(19) United States
(12) Patent Application Publication
(10) Pub. No.: US 2004/0030674 A1
(43) Pub. Date: Feb. 12, 2004

(54) Web service coordination plan creating apparatus, Web service coordination plan creating method, and program and recording medium

(76) Inventors: Shinichi Nagano, Yokohama-shi (JP); Yasuyuki Tahara, Ichikawa-shi (JP); Tetsuo Hasegawa, Tokyo (JP); Akihiko Ohsuga, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/627,779

(22) Filed: Jul. 28, 2003

(30) Foreign Application Priority Data
Jul. 29, 2002 (JP) 2002-220174

(51) Int. Cl. G06F 7/00

(52) U.S. Cl. 707/1

(57) ABSTRACT

A Web service coordination plan creating method according to this invention includes a first step of matching the predicate of the precondition with the predicate of the user data and matching the predicate of the post condition with the predicate of the user's request in respect to one application program. The method further includes a second step of matching the predicate of the precondition with a first predicate including the predicate of the user data unmatched in the first step and matching the predicate of the post condition with a second predicate including the predicate of the user's request unmatched in the first step in respect to other application programs excluding the one application program.

### CROSS-REFERENCE TO RELATED APPLICATIONS

This application is based upon and claims the benefit of priority from the prior Japanese Patent Application No. 2002-220174, filed Jul. 29, 2002, the entire contents of which are incorporated herein by reference.

### BACKGROUND OF THE INVENTION

1. Field of the Invention

This invention relates to an Web service coordination plan creating apparatus, an Web service coordination plan creating method, and a program and a recording medium. More specifically, this invention relates to an Web service coordination plan creating apparatus, an Web service coordination plan creating method, and a program and a recording medium which are associated with a plurality of application programs accessible via a network.

2. Description of the Related Art

Recently, service registry technologies have attracted attention. UDDI (Universal Description, Discovery, and Integration) is one of international standards for such registry technologies, and is a global database used for the discovery and registration of Web services existing on the Internet. In UDDI, information on what Web services are present on the Internet is registered beforehand in a database called a registry. An User can find Web services by searching the database.

The UDDI registry enables a Web service provider to register the information related to Web services that it offers, including service names, registrants, and URLs (Uniform Resource Locators). A Web service requester can find the necessary Web service by searching for the data in the registry, using the word related to the service as a keyword.

However, such a keyword search does not provide enough way for a Web service requester to search for a Web service the requester desires. It is because the term that the requester enters must be registered in the UDDI registry for the discovery of Web services. Specifically, when a keyword having the same meaning as that of the term registered in the registry but differing in reading has been specified by the searcher, the searcher cannot search for the desired Web service.

When a plurality of terms have been specified by the searcher, if all of the terms have not been registered in the registry, the searcher cannot search for the desired Web service. Specifically, when only a part of the terms specified by the searcher has been registered in the registry, even if a Web service searchable from the part of the terms exists, the Web service is regarded as not satisfying the searcher's request and therefore is not included in the result of the search.

For such a reason, the existing technique may be able to meet the searcher's request by coordinating a plurality of Web services with one another, but cannot produce a combination of such Web services as the result of the search.

### BRIEF SUMMARY OF THE INVENTION

It is an object of the present invention to provide an Web service coordination plan creating apparatus, an Web service coordination plan creating method, a program, and a recording method which, when the request of a service requester may be satisfied by coordinating Web services, can produce a coordination plan of the Web services.

According to an aspect of the present invention, there is provided an Web service coordination plan creating apparatus, comprising: a first storage section which stores user data that makes predicates indicating a states of a user; a second storage section which stores a database that associates preconditions representing, in predicate form, necessary conditions for users to use Web services via an information communication network, with post conditions representing, in predicate form, the effects of invocation of the corresponding Web services; and coordination plan creating means for, when receiving a user's request including search conditions for the Web services, acquiring matching user data in predicate form corresponding to the user's request from the first storage section, acquiring from the second storage a combination of Web services which satisfies the user's request by logically combining the preconditions and post conditions for a plurality of Web services including a Web service having the preconditions matching with the user data and a Web service having the post conditions matching with the user data, and creating a Web service coordination plan where the individual Web services included in the combination are arranged in the order of the logical combination.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the configuration of an application program plan creating system related to an embodiment of the present invention;

FIG. 2 shows the configuration of the web server 1 in FIG. 1;

FIG. 3 is a table to help explain the data structure of the user data section 12 in FIG. 2;

FIG. 4 is a diagram to help explain the data structure of the ontology dictionary section 13 in FIG. 2;

FIG. 5 is a table to help explain the data structure of the Web service data section 14 in FIG. 2;

FIG. 6 is a flowchart showing an example of the processing procedure for the plan creating section of FIG. 2;

FIG. 7 is a flowchart to help explain the procedure for a plan creating procedure process (step S1) of FIG. 6;

FIG. 8 is a flowchart to help explain another example of the processing procedure for the plan creating section 11 of FIG. 2; and

FIG. 9 is a detailed flowchart to help explain the procedure for the plan creating procedure process (step S3) of FIG. 8.

### DETAILED DESCRIPTION OF THE INVENTION

Hereinafter, referring to the accompanying drawings, embodiments of the present invention will be explained.

The term “section” in this specification conceptually represents the function of realizing the effect of the present invention and does not necessarily correspond to specific hardware or a software routine in a one-to-one correspondence. Thus, in the explanation below, the function of realizing the effect of the present invention is shown as a circuit block (section) hypothetically. The processes performed by the individual blocks are realized by the computing process of a CPU (Central Processing Unit) on the basis of a program loaded into, for example, the main memory.

The order in which the individual steps in the flowcharts shown in the embodiment may be changed or more than one step may be executed at a time, as long as the change does not go against the aims of the steps.

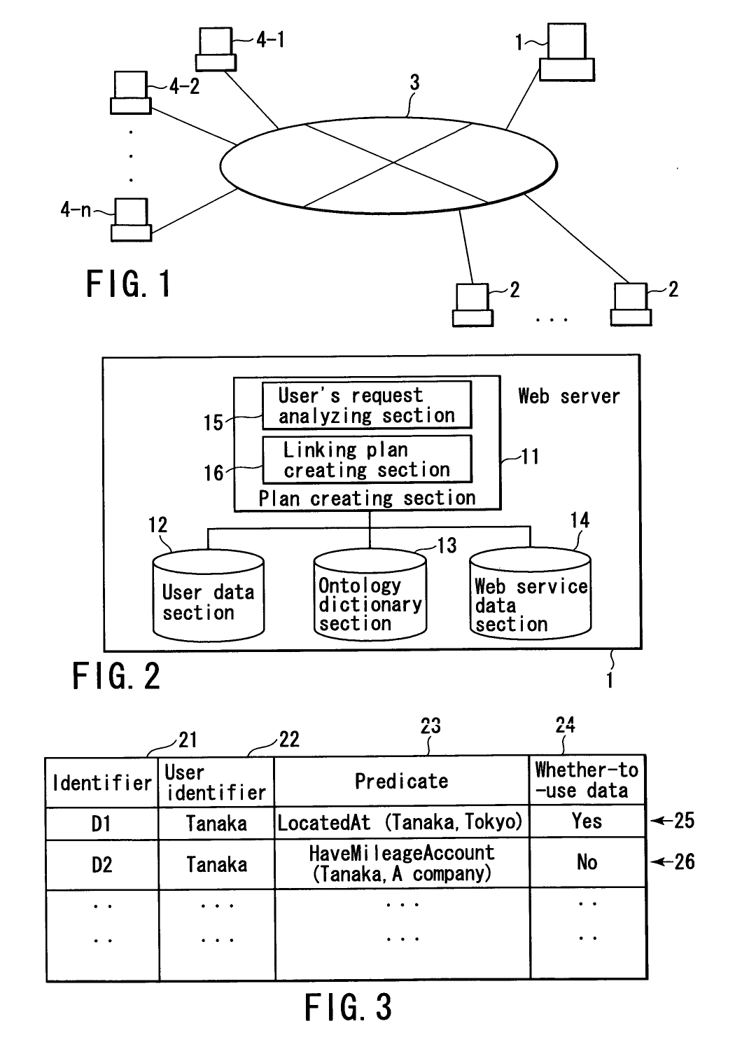

Referring to FIG. 1, the configuration of a system related to the embodiment will be explained. FIG. 1 shows the configuration of an application program plan producing system according to the embodiment.

Numeral 1 indicates a web server apparatus (hereinafter, referred to as a web server). Numeral 2 indicates a personal computer (hereinafter, referred to as a PC) used by a user.

The web server 1 and a plurality of PCs 2 are connected to the Internet 3. Numerals 4-1 to 4-n (n is an integer) denote service providing computers which each have a Web service program. The n number service providing computers 4-1 to 4-n are also connected to the Internet 3 as are the web server 1 and PCs 2.

Web services are application programs accessible through the Internet. (Thus, hereinafter, Web services are also referred to as application programs.) A user, a person or a computer program, calls an application programs via the Internet. In response to the call, the application program is executed, thereby enabling the user to use the result of the execution.

The application program plan producing system is a system which, receiving the request from PC2, the user, transmits and produces information about the Web service satisfying the request as a plan to PC2. The information about the Web service satisfying the user's request includes a linking plan obtained by combining a plurality of Web services.

A plan is information including data for defining an application program, such as a Web service identifier. A linking plan is a combination of data items for defining an application program. The linking plan includes a list where, for example, Web service identifiers are ordered. In this embodiment, a Web service identifier list is represented with “;” between identifiers.

The information about Web services includes Web service identifiers, parameters necessary for calling Web services, and data on the functions of Web services. The request of PC2 is transmitted from PC 2 to the web server 1, when a person operates PC2. In addition, the request of PC2 is created by a computer program executed on PC2 and then is transmitted to the web server 1.

In the explanation below, the Web services are assumed to be application programs making use of the Internet. The Web services may be application programs which can be accessed by the user through a communication channel other than the Internet.

The web server 1 includes a database called a registry. In the registry, Web service data showing what Web services are present on the Internet 4 is registered beforehand. The user searches for the Web service data registered in the registry. Then, the user can acquire information about the Web services, such as the presence or absence of the desired Web service or a method of calling the Web service.

FIG. 2 shows the configuration of the web server 1 in FIG. 1. The web server apparatus 1 is an apparatus for creating and producing an application program plan. The web server apparatus 1 comprises a plan creating section 11, a user data section 12, an ontology dictionary section 13, and a Web service data section 14. The data in the user data section 12, the data in the ontology dictionary section 13, and the data in the Web service data section 14 is stored in respective memories.

The plan creating section 11 creates information about Web services satisfying the user's request. The ontology dictionary section 13 is a database that relates predicates describing the user's request and Web services to one another to systematize them.

A predicate is a notation in predicate logic. Specifically, a plurality of nodes are related to one another in tree form. At each node, a predicate is defined. The Web service data section 14 includes Web service data, or Web service definition information. The Web service data is registered in the registry.

The plan creating section 11 includes a user's request analyzing section 15 and a linking plan creating section 16. The user's request analyzing section 15 is a program for analyzing the request received via the Internet from PC 2, the user. The contents of the processing of the linking plan creating section 16 will be explained later.

The user data section 12, ontology dictionary section 13, and Web service data section 14 are not necessarily provided in the web server 1. For instance, the user data section 12, ontology dictionary section 13, and Web service data section 14 may be provided in the memory device in another information processing apparatus connected to the web server 1 via a network (not shown) provided separately.

FIG. 3 is a table to help explain the data structure of the user data section 12 in FIG. 2. FIG. 3 shows only two pieces of data about a certain user (Mr. Tanaka). In practice, a plurality of pieces of data about a plurality of users are stored in the user data section 12.

In FIG. 3, each piece of user data includes four items of data, including an identifier 21, a user identifier 22, a predicate 23, and whether-to-use data 24. The user data is data about condition information about the user, information about the result of uses, and the like. The identifier 21 is data for identifying each piece of user data. The user identifier 22 is data for identifying the user.

The predicate 23 is data where the contents of the result of uses or the like are written in predicate form. The whether-to-use data 24 is data for indicating whether to use the user data (or whether the user data is usable?).

In the user data 25, the identifier 21 is “D1”, the user identifier 22 is “Tanaka”, the predicate 23 is “LocatedAt (Tanaka, Tokyo), and the whether-to-use data is “Yes”.

In the predicate 23 of FIG. 3, for example, the part “LocatedAt” is a predicate symbol and the part “(Tanaka, Tokyo)” is an argument. Thus, “LocatedAt (Tanaka, Tokyo)” in the predicate 23 means that “Tanaka, user, lives in Tokyo”. “Yes” in the whether-to-use data 24 means that “the user data 25 is to be used in creating a plan”.

Similarly, the identifier 21 in the user data 26 is “D2”, the user identifier 22 is “Tanaka”, the predicate 23 is “HaveMileageAccount (Tanaka, A company)”, and the whether-to-use data 24 is “No”.

In the predicate 23 of FIG. 3, “HaveMileageAccount (Tanaka, A company)” means that “Tanaka, user, has company A's mileage account”. “No” in the whether-to-use data 24 means that “the user data 26 is not to be used in creating a plan”.

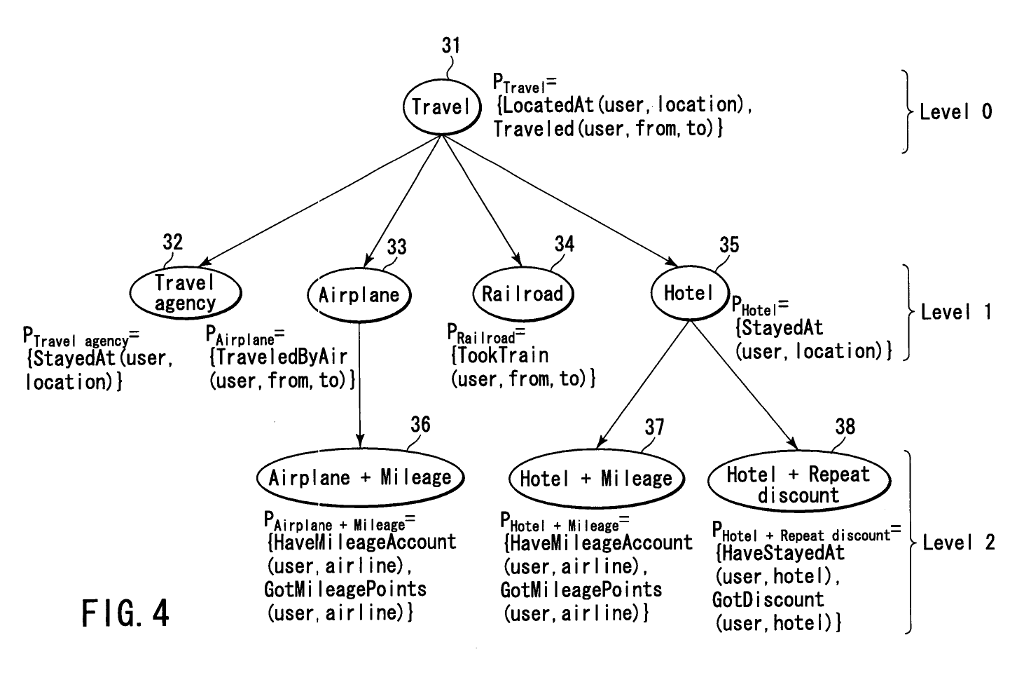

FIG. 4 is a diagram to help explain the data structure of the ontology dictionary section 13 of FIG. 2. The ontology dictionary section 13, which is the data in the dictionary where predicates are classified, is composed of links connecting nodes. In FIG. 4, a root node 31 with the label “Travel” as an identifier is linked to four nodes, 32, 33, 34, 35. That is, the root node 31 is connected to nodes 32, 33, 34, and 35.

The label “Travel agency” is put on node 32. The label “Airplane” is put on node 33. The label “Railroad” is put on node 34. The label “Hotel” is put on node 35.

Node 33 is further connected to node 36. The label “Airplane+Mileage” is put on node 36. Node 35 is further connected to nodes 37, 38. The label “Hotel+Mileage” is put on node 37. The label “Hotel+Repeat discount” is put on node 38.

A predicate is defined for each node. That is, a predicate is related to each node. In other words, each node has data about a set of predicates related to one another.

In FIG. 4, equation P represents a set of predicates. For example, two predicates are defined for node 31. That is, node 31 has data about a set of two predicates, “LocatedAt (user, location)” and “Traveled (user, from, to)”. On the other hand, node 32 has data about a set of one predicate “StayedAt (user, location)”.

As shown in FIG. 4, the ontology dictionary section 13 has a hierarchical tree structure of predicates. In FIG. 4, node 31 is assumed to be at level 0 (zero). Nodes 32 to 35 connected to nodes at level 0 are assumed to be at level 1. Nodes 36 to 38 connected to nodes at level 1 are assumed to be at level 2.

When the data in the ontology dictionary section 13 is used, a level to be used is specified. For example, when level 0 is specified, the terms at level 1 and level 2 are not used. When level 1 is specified, the terms at level 0 and level 1 are used, but the terms at level 2 are not used. When level 2 is specified, the terms at level 0, level 1, and level 2 are used. In this way, specifying the depth of terms to be used makes it possible to change the range of the related terms.

For example, it is assumed that, when logical expression data is created on the basis of the user's request, the dictionary data in the ontology dictionary data 13 is used. In this case, when level 0 is specified, logical expression data where only the term requested by the user is a predicate is created. If level 1 is specified, logical expression data is created by using not only the term requested by the user but also a term connected to the term in relation to level 1.

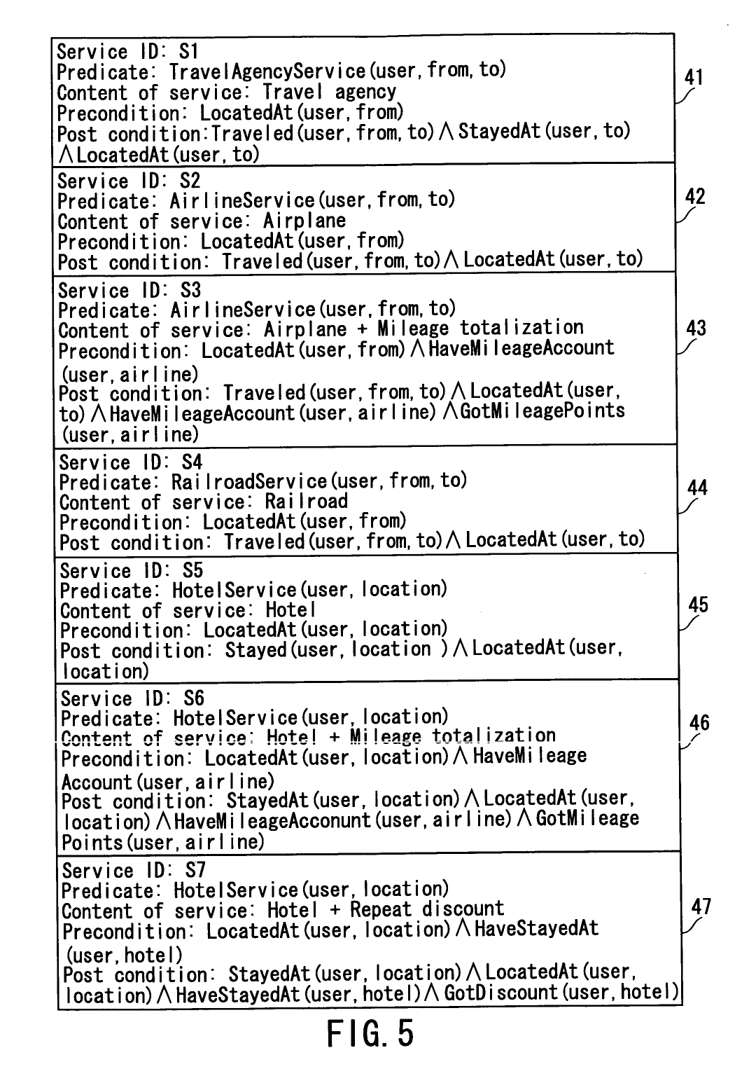

FIG. 5 is a table to help explain the data structure of the Web service data section 14 of FIG. 2. FIG. 5 shows seven pieces of Web service data 41 to 47. In FIG. 5, each of the individual pieces of Web service data 41 to 47 includes a service ID, a predicate, the contents of service, and Web service descriptive data about the items of preconditions and post conditions as Web service definition information.

A service ID is data for identifying each Web service. For example, the service ID in the Web service data 41 is “S1”.

A predicate is composed of a predicate symbol and an argument. The argument is shown in parentheses. In the Web service data 41, “Travel Agency Service” is a predicate symbol and “user, from, to” in parentheses is an argument. The predicate shows the contents of the service available in the Web service. Thus, it is seen that the service “Travel Agency Service” is available in the Web service data 41.

In the contents of the service, the contents of the service in the Web service are written in natural language. For example, the contents of the service in the Web service data 41 show that they are related to “Travel agency”.

An precondition, which is a necessary condition for receiving the Web service, is written in a predicate. Thus, when the precondition “LocatedAt (user, from)” in the Web service data 41 is fulfilled, the service requester can use the Web service.

An post condition, which is the result or effect of receiving the Web service, is written in a predicate. The post condition in the Web service data 41 is expressed by the logical expression “Traveled (user, from, to) [symbol] StayedAt (user, to) [symbol] LocatedAt (user, from)”. That is, the post condition is the logical product of three predicates in the Web service data 41.

In the predicates, precondition, and post condition, arguments are variables.

Similarly, the service ID in the Web service 42 is “S2”. It is seen that the service “Airline Service” using “user, from, to” as an argument is available in the Web service 42. The contents of the service in the Web service 42 relates to “Airplane”. The precondition is the predicate “LocatedAt (user, from)”. The post condition is “Traveled (user, from, to) [symbol] LocatedAt (user, from)”. In the Web service data 42, the post condition is the logical product of two predicates.

Similarly, service IDs, predicates, the contents of services, preconditions, and post conditions are also defined for the pieces of Web service data 43 to 47.

Next, how a plan satisfying the service requester's request is shown to the user by using the various types of data will be explained by means of examples. A case where, to make a trip, a person searches for Web services providing various pieces of information on the trip will be explained.

(First Embodiment)

In FIG. 1, PC2, the user transmits request data for making a request to search for Web services about travel to the Web service 1 via the Internet 4. The request data includes information about a traveler, a departure place, a destination, and others. PC2 creates request data on the basis of a predetermined program and transmits it to the web server 1. In the first embodiment of the present invention, the following situation is assumed: “Tanaka” makes a trip from “Tokyo” to “Osaka” and stays in “Osaka”. When these pieces of information are inputted to PC2, PC2 creates request data reflecting the situation and transmits it to the web server 1.

Next expression (1) represents request data reflecting the situation.

Traveled (Tanaka, Tokyo, Osaka) [symbol] StayedAt (Tanaka, Osaka) (1)

In expression (1), the request data is expressed in logical expression form. That is, the form of expression (1) is the logical product of two predicates.

The entity that creates request data may be PC2 or the web server 1. That is, the web server 1 may create request data on the basis of the information transmitted from PC 2.

When receiving the request data, the web server 1 senses that “Tanaka” is included as user data in the received request data. Then, the web server 1 searches the user data section 12 of FIG. 2 and extracts user data about “Tanaka”. Suppose two pieces of user data 25, 26 shown in FIG. 3 have been extracted as a result of the search.

Next, the web server 1 carries out a matching process of an precondition predicate and a user data predicate. The matching process is the process of checking whether two predicates coincide with each other. Specifically, in the matching process, the predicate symbols and arguments of two predicates are regarded as symbols (or strings) and it is determined whether the two symbols (or character strings) coincide with each other.

As shown in FIG. 3, whether-to-use data 24 in the user data 26 is “No”. Thus, “HaveMileageAccount” in the user data 26 is excluded from the items to be subjected to matching. Thus, in the matching process of the first embodiment, it is determined whether there is a thing coinciding with the predicate symbol in the precondition of the Web service data in the predicate symbol “LocatedAt” in the user data 25. In the Web service data of FIG. 5, all of the seven pieces of Web service data meet the coincidence condition on the assumption that the predicate symbol “LocatedAt” is included in the precondition.

Next, the web server 1 substitutes a value into the argument of the precondition “LocatedAt (user, from” and carries out a unification process, thereby creating predicate data.

A unification process is to do matching by replacing the value of the variable in the predicate with a certain value. In the first embodiment, from the user data “LocatedAt (Tanaka, Tokyo)” and the precondition “LocatedAt (user, from)”, the predicate data “LocatedAt (Tanaka, Tokyo)” is created by a unification process giving user=Tanaka, from=Tokyo.

Next, the web server 1 creates predicate data about the post condition through a unification process based on the predicate included in the request data shown in expression (1). The post condition in the Web service data 41 is expressed as the logical expression “Traveled (user, from, to) [symbol] StayedAt (user, to) [symbol] LocatedAt (user, from)”. Substituting the value of expression (1) into the logical expression gives “Traveled (Tanaka, Tokyo, Osaka) A StayedAt (Tanaka, Osaka) [symbol] LocatedAt (Tanaka, Osaka)”. Here, “LocatedAt (Tanaka, Osaka)” means that, as a result of the movement of “Tanaka”, “Tanaka” is in “Osaka”.

When the unification process of the precondition for a certain Web service has succeeded, the same unification is applied to the post condition for the Web service. That is, the post condition is not unified independently of the precondition.

If the unification process of the predicate for the precondition in the web server 1 or the matching process has failed, the user cannot receive the desired Web service. Moreover, even if a predicate for the precondition is created, the user cannot use the Web service, unless the predicate for the post condition obtained by the unification process satisfies the predicate of the user's request.

In an example shown in FIG. 5, predicates for the precondition can be created for Web services 41 to 47. However, predicates for the post condition fulfilling the user's request cannot be created for the Web services excluding the Web service 41. Thus, only the Web service data 41 satisfies the user's request. That is, the Web service 41 can be set as one of the plans fulfilling the user's request.

In the above procedure, whether the user's request can be satisfied is determined on the basis of a certain Web service. Furthermore, in the first embodiment, it is determined whether the user's request can be med by combining a plurality of Web services.

For example, in the case of the pieces of Web service data 42 and 44, both of the pieces of Web service data don't have predicates with the descriptive symbol “StayedAt” in the post condition. Thus, from these pieces of data, predicates for “StayedAt (user, to)” cannot be created. However, concerning “Traveled (user, from, to)” and “LocatedAt (user, from)”, two predicates, “Traveled (Tanaka, Tokyo, Osaka)” and “LocatedAt (Tanaka, Osaka)”, can be created by a unification process.

Using these predicates as the precondition, the web server 1 searches the Web service data for a piece of data capable of creating the predicate “StayedAt (user, to)”. That is, by linking to one piece of Web service data incapable of providing the Web service requested by the user, another piece of Web service data capable of providing the Web service meeting the user's request is searched for.

Specifically, the web server 1 matches the created predicate data with the predicate data about the precondition in another piece of Web service data. In other words, when the predicate of the post condition created from certain Web service data fulfills the precondition for another Web service data, the web server 1 checks whether the predicate of the post condition created from second Web service data fulfills the predicate of the user's request not satisfied yet.

For example, for Web service 42, the post condition predicate “Traveled (Tanaka, Tokyo, Osaka)” and the predicate “LocatedAt (Tanaka, Osaka)” are created. Giving priority to the created predicate, the web server 1 creates the predicate of an post condition from services excluding Web service 42. Services excluding Web service 42 include the predicate “LocatedAt (Tanaka, Osaka)” as an precondition. Then, the web server 1 combines the predicate of the post condition with the post condition created in Web service 42, thereby determining whether to satisfy the user's request.

Since the precondition in the Web service 43 includes “HaveMileageAccount”, neither the Web service data 42 nor the user data satisfies the precondition. However, since the pre ante condition in the Web service 45 has only the predicate “LocatedAt (Tanaka, Osaka)”, use of the Web service data 42 and the user data makes it possible to fulfill the pre ante condition in the Web service 45. Furthermore, the post condition in the Web service data 45 includes “StayedAt (Tanaka, Osaka)” and “LocatedAt (Tanaka, Osaka)”. Thus, combining pieces of Web service data 42, 45 makes it possible to satisfy the user's request.

Similarly, the user's request may be satisfied by combining the pieces of Web service data 44 and 45.

As described above, the web server 1 determines whether the user's request can be met by combining a plurality of Web services. This enables the web server 1 to show a plan including not only a Web service covered by only one Web service but also a combination of a plurality of Web services in response to the user's request.

The web server 1 produces, for example, the following plan:

Plan P={S1, S2; S5, S4; S5}

In this plan, Web service information about three choices, one Web service S1, a combination of Web services S2, S5, a combination of Web services S4, S5, is presented to the user. A combination of S2 and S5 means that the user can receive the Web service satisfying the user's request by receiving service S2 and then service S5.

In the above example, when receiving from the user a request to know Web services about trips including accommodations, the web server 1 first determines that the Web service 41 can satisfy the user's request. In addition, the web server 1 determines that a combination of Web service 42 or 44 providing transportation means and Web service 45 providing accommodation means can also satisfy the user's request. Then, the web server 1 presents to PC2 a plan including Web service 41 and a combination of Web service 42 or 44 and Web service 45.

This enables the user to receive not only one Web service but also a combination of Web services as a service plan satisfying the user's request. Thus, the user can get more pieces of information to satisfy the user's request than in the existing system.

In other words, in the existing system, only one Web service fulfilling the user's request is presented to the user. In contrast, in the first embodiment, not only one Web service but also a combination of Web services are presented to the user. Thus, the user has a wider range of selection.

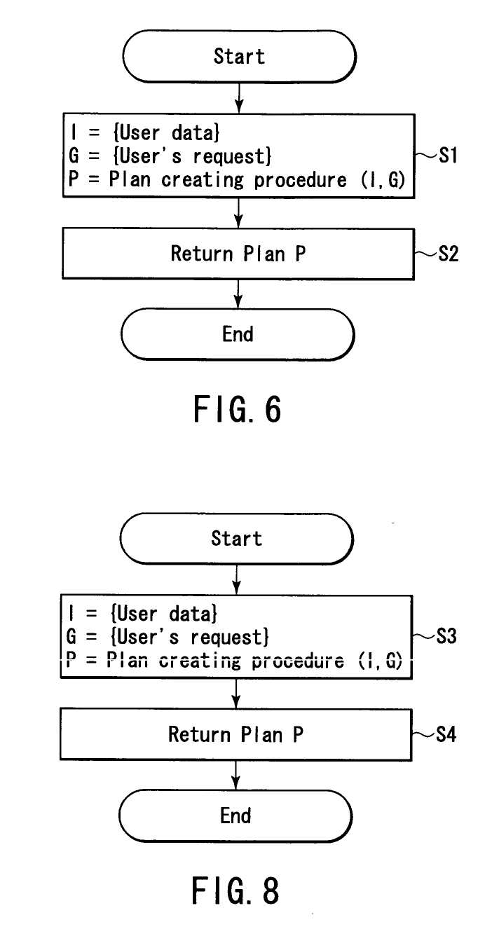

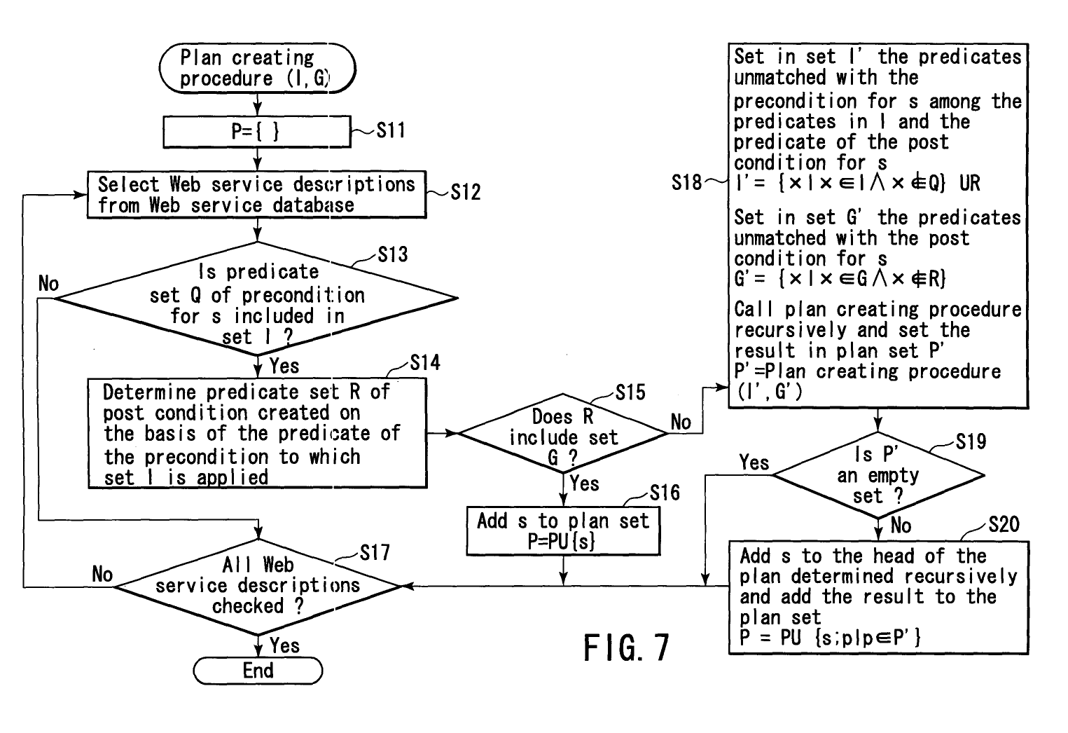

Next, the process carried out by the web server 1 will be explained in detail by reference to FIGS. 6 and 7.

FIG. 6 is a flowchart showing an example of the processing procedure for the plan creating section of FIG. 2.

A preliminary process will be explained. When the web server 1 receives the user's request from PC2, the user's request analyzing section 15 (see FIG. 2) analyzes the request data and creates request data in logical expression form. That is, if the request data transmitted from PC2 is not in logical expression form, the user's request analyzing section 15 converts the received request data into such logical expression form as shown in expression (1) including a predicate. Specifically, the user's request analyzing section 15 refers to the data in the ontology dictionary section 13 on the basis of the result of the analysis of the request data and relates terms up to the specified level to one another, thereby performing the converting process. If the request data transmitted from PC2 is in logical expression form, it is not necessary to carry out the converting process. Then, the user's request analyzing section 15 gives the request data in logical expression form to the linking plan creating section 16.

In FIG. 6, after the completion of the preliminary process, the linking plan creating section 16 executes a plan creating procedure process using the user data and the user's request (step S1). The user data is a set I of predicates in the user data. The user request is a set G of created predicates. A plan to be created is a set P of plans. The details of the processing in this step will be explained later by reference to FIG. 7. Next, the web server 1 returns the plan created by the linking plan creating section 16 to PC2 that transmitted the user's request (step S2).

FIG. 7 is a flowchart to help explain the procedure for the plan creating procedure process (step S1) of FIG. 6 in detail. First, the linking plan creating section 16 clears the data about plans (step S11). As a result, nothing is included in the set P of plans.

Next, the linking plan creating section 16 selects Web service descriptions from the Web service data (step S12). In this step, the Web service description indicated by numeral 41 in FIG. 5 is selected.

Then, the linking plan creating section 16 determines whether a predicate set Q of the preconditions for the selected Web service descriptions is included in the set I of predicates in the user data (step S13). That is, the linking plan creating section 16 matches the predicate set Q of the preconditions for the selected Web service predicates indicated by numeral 41 with the set I of predicates in the user data.

By a unification process giving user=Tanaka, from=Tokyo, the predicate of the precondition in the Web service data 41 is “LocatedAt (Tanaka, Tokyo)”. This is included in the user data 25. Thus, in step S13, “Yes” is given and the processing procedure proceeds to step S14. If “No” is given in step S13, the processing procedure proceeds to step S17.

In step S14, a set R of predicates for the post condition created on the basis of the predicate of the precondition to which the user data set I is applied is obtained. For example, when a predicate for the post condition is determined using “LocatedAt (Tanaka, Tokyo)” in the user data as a predicate for the precondition in the Web service data 41, this gives a set of predicates, {Traveled (Tanaka, Tokyo, Osaka), StayedAt (Tanaka, Osaka), LocatedAt (Tanaka, Osaka)}.

Next, the linking plan creating section 16 determines whether the set R of predicates for the created post condition includes the set G of predicates for the user's request (step S15). That is, the linking plan creating section 16 matches the set R of predicates for the created post condition with the set G of predicates for the user's request.

The set R of predicates for the post condition for the Web service 41 is {Traveled (Tanaka, Tokyo, Osaka), StayedAt (Tanaka, Osaka), LocatedAt (Tanaka, Osaka)}. The set G of predicates for the user's request is {Traveled (Tanaka, Tokyo, Osaka), StayedAt (Tanaka, Osaka)}. Thus, the set R of predicates for the post condition includes the set G of predicates for the user's request. Thus, in step S15, “Yes” is given and the processing procedure proceeds to step S16.

In step S16, “s” is added to the plan set P. This process is expressed by the following equation:

P=P∪{s}

Adding S1, the service ID of the Web service data 41, to the plan set P gives P={S1}.

Next, the linking plan creating section 16 determines whether the descriptions of all the Web services have been checked (step S17). Taking FIG. 5 as an example, since six pieces of Web service data 42 to 47 are left in addition to the piece of Web service data 41, “No” is given in step S17 in this stage and the processing procedure returns to step S12.

Next, the linking plan creating section 16 carries out the same process for the pieces of Web service data 42. That is, the linking plan creating section 16 selects the Web service descriptions indicated by numeral 42 in FIG. 5 (step S12).

Then, the linking plan creating section 16 determines whether the predicate set Q of preconditions for the selected Web service descriptions is included in the user data set I (step S13). That is, the linking plan creating section 16 matches the predicate set Q of preconditions for the Web service descriptions indicated by numeral 42 with the user data predicate set I.

By a unification process giving user=Tanaka, from=Tokyo, the predicate of the precondition in the Web service data 41 is “LocatedAt (Tanaka, Tokyo)”. This is included in the user data 25. Thus, in step S13, “Yes” is given and the processing procedure proceeds to step S14.

In step S14, a set R of predicates for the post condition created on the basis of the predicate of the precondition to which the user data set I is applied is obtained. For example, when a predicate for the post condition is determined using “LocatedAt (Tanaka, Tokyo)” in the user data as the predicate of the precondition in the Web service data 42, this gives a set of predicates, {Traveled (Tanaka, Tokyo, Osaka), LocatedAt (Tanaka, Osaka)}.

Next, the linking plan creating section 16 determines whether the set R of predicates for the created post condition includes the set G of predicates for the user's request (step S15). The set R of predicates for the post condition in the Web service 42 is {Traveled (Tanaka, Tokyo, Osaka), LocatedAt (Tanaka, Osaka)}. The set G of predicates for the user's request is {Traveled (Tanaka, Tokyo, Osaka), StayedAt (Tanaka, Osaka)}. Thus, the set R of predicates for the post condition does not include the set G of predicates for the user's request. Thus, in step S15, “No” is given and the processing procedure proceeds to step S18.

In step S18, the linking plan creating section 16 sets the predicates unmatched with the precondition for the selected Web service descriptions among the predicates in the user data set I and the predicate x of the post condition for the Web service descriptions in a set (I′). This process is expressed by equation (2):

I′={x|x∈I [symbol] x∈Q}∪R (2)

That is, I′={the predicates unmatched with the predicate of the precondition for the selected Web service descriptions among the predicates in the set I}∪{the predicate for the post condition for the selected Web service descriptions}.

As for the Web service data 42, all of the predicates in the user data set I match with the precondition for the selected Web service descriptions. Thus, the predicates “Traveled (Tanaka, Tokyo, Osaka” and “LocatedAt (Tanaka, Osaka)” for the post condition are set in the set (I′).

Next, the linking plan creating section 16 sets the predicates unmatched with the post condition for the selected Web service descriptions among the predicates in the user request set G. This process is expressed by equation (3):

G′={x|x∈G [symbol] x∉R} (3)

That is, G′={the predicates unmatched with the predicate of the post condition for the selected Web service descriptions among the predicates in the set G}.

As for the Web service data 42, the predicate “StayedAt (Tanaka, Osaka)” does not match with the post condition, this is set in the set (G′).

Furthermore, the linking plan creating section 16 calls the plan creating procedure recursively and sets the result in a plan set P′. This process is expressed by equation (4):

P′=plan creating procedure(I′, G′) (4)

In the Web service data 42, the set (I′) is {Traveled (Tanaka, Tokyo, Osaka), LocatedAt (Tanaka, Osaka)} and the set (G′) is {StayedAt (Tanaka, Osaka)}. Thus, on the basis of the set (I′) and the set (G′), the process of FIG. 7 is called recursively, with the result that the plan set (P′) is created.

Next, the linking plan creating section 16 determines whether the set P′ is an empty set (step S19). If the set P′ is an empty set, “Yes” is given in step S19 and the processing procedure goes to the process in step S17. If the set P′ is not an empty set (No in step S19), the processing procedure proceeds to step S20.

In step S20, “s” is added to the head of the plan determined recursively and the resulting plan is added to the set P of plans. This process is expressed by the following equation (5):

P=P∪{s;p|p∈P′} (5)

In the Web service data 42, the Web service data 45 is included in the plan P′. Thus, “S2, S5” in the Web service data 42 are added to S1 in the Web service data 41, with the result that the set P is {S1, S2; S5}. That is, calling the Web service S5 after the Web service S2 causes a plan capable of fulfilling the user's request to be added.

Next, the linking plan creating section 16 determines whether the descriptions of all the Web services have been checked (step S17). In this stage, too, the processing procedure returns to step S12, where a similar processing procedure is carried out for the next Web service data 43.

The precondition in the Web service data 43 is “LocatedAt (user, from) [symbol] HaveMileageAccount (user, airline)” and whether-to-use information in the user data 26 is “No”. Thus, “No” is given in step S13 and the processing procedure proceeds to step S17, where a similar processing procedure is executed for the next Web service data 44.

The result of processing the Web service 44 is almost the same as that of the Web service data 42 (because explanation of the details of the processing procedure is redundant, it will be omitted). Thus, “S4, S5” in the Web service data 44 are added to the set P, with the result that the set P becomes {S1, S2; S5, S4; S5}. That is, calling the Web service S5 after the Web service S4 causes a plan capable of satisfying the user's request to be added. Similarly, the procedure of FIG. 7 is carried out for up to the Web service data 47.

As a result of such processes, three plans satisfying the user's request are created. The web server 1 then transmits them to PC2. That is, the data corresponding to the set P (={S1, S2; S5, S4; S5}) is returned to PC2 that transmitted the user's request. PC2 shows the data to the user. Although a plurality of pieces of list data about the identifiers of the Web service descriptions in the Web service data have been returned, data other than the identifiers may be returned.

Next, a case where whether-to-use data in the user data 26 of FIG. 3 is “Yes” will be explained.

If whether-to-use data in the user data 26 is “Yes”, the user data set I is {LocatedAt (Tanaka, Tokyo), HaveMileageAccount (Tanaka, A company)}. In this case, since the processing procedure for the Web services S1, S2 is the same as described above, its explanation will be omitted.

As for the Web service S3, since the precondition predicate set {LocatedAt (Tanaka, Tokyo), HaveMileageAccount (Tanaka, A company)} is included in the user data set I, “Yes” is given in step S13 of FIG. 7. Since the post condition predicate set {Traveled (Tanaka, Tokyo, Osaka), LocatedAt (Tanaka, Osaka), HaveMileageAccount (Tanaka, A company), GotMileagePoints (Tanaka, A company)} does not include the user's request predicate set G, “No” is given in step S15. As a result, the processing procedure goes to step S18.

In step S18, the linking plan creating section 16 creates the set (I′), which gives I′={the predicates unmatched with the predicate for the precondition in the Web service S3 among the predicates in the set I}∪{the predicate for the post condition in the Web service S3}={ }∪{Traveled (Tanaka, Tokyo, Osaka), LocatedAt (Tanaka, Osaka), HaveMileageAccount (Tanaka, A company), GotMileagePoints (Tanaka, A company)}={Traveled (Tanaka, Tokyo, Osaka), LocatedAt (Tanaka, Osaka), HaveMileageAccount (Tanaka, A company), GotMileagePoints (Tanaka, A company)}.

Next, the linking plan creating section 16 creates the set (G′), which gives G′={the predicates unmatched with the predicate for the post condition in the Web service S3 among the predicates in the set G}={StayedAt (Tanaka, Osaka)}.

Then, the linking plan creating section 16 calls the plan creating procedure recursively on the basis of the set I′ and the set G′ and carries out it, thereby searching for the Web service that satisfies “StayedAt (Tanaka, Osaka)”.

Since the predicate set {LocatedAt (Tanaka, Tokyo), HaveMileageAccount (Tanaka, A company)} of the precondition in the Web service S6 is included in the set (I′), “Yes” is given in step S13. Furthermore, since the post condition predicate set {StayedAt (Tanaka, Osaka), LocatedAt (Tanaka, Osaka), HaveMileageAccount (Tanaka, A company), GotMileagePoints (Tanaka, A company)} includes the set (G′), “Yes” is given in step S15. As a result, “S3; S6” is added to the plan P. That is, data corresponding to the set P (={S1, S2; S5, S3; S6, S4; S5}) is returned to PC2 that transmitted the user's request.

As described above in detail, with the first embodiment, the user can receive not only one Web service but also a combination of a plurality of Web services as a service plan satisfying the user's request. Therefore, the user can get more Web service information satisfying the user's request than in a conventional equivalent.

(Second Embodiment)

Next, a second embodiment of the present invention will be explained. In the second embodiment, too, the same situation as in the first embodiment is assumed. Thus, in the second embodiment, too, the request data transmitted from PC2 to the web server 1 includes the same information as expression (1).

The web server 1, receiving the request data, can sense on the basis of the received request data that “Tanaka” is included as one item of user data. Thus, the web server 1 searches the user data section 12 for the data in FIG. 3 and extracts user data about “Tanaka”. As a result, it is assumed that two items of user data shown in FIG. 3 have been extracted.

Next, the web server 1 carries out a matching process of the predicate of the post condition and the predicate of the request data. That is, the web server 1 determines whether the predicate symbols in the request data (expression 1) has any one coinciding with the predicate symbol in the post condition in the Web service data. In the Web service data of FIG. 5, only the Web service data 41 meets the requirement, provided that the two predicate symbols “Traveled” and “StayedAt” are included in the post condition.

Then, values are substituted into the variables “user, form, to” in “Traveled (user, from, to)” and “Stayedat (user, to)” in the post condition, thereby creating predicate data for unification. In the second embodiment, by a unification process giving user Tanaka, from=Tokyo, to=Osaka, three items of predicate data, “Traveled (Tanaka, Tokyo, Osaka” and “StayedAt (Tanaka, Osaka)” and “LocatedAt (Tanaka, Osaka)”, are created from “Traveled (Tanaka, Tokyo, Osaka)” and “StayedAt (Tanaka, Osaka)” in the request data and “Traveled (user, from, to)” and “StayedAt (user, to)” in the post condition.

Next, after the unification of the post condition in a certain Web service has succeeded, the same unification is applied to the precondition in the same Web service. That is, the precondition is not unified independently of the post condition. The request data and the successful unification giving user=Tanaka, from=Tokyo, to=Osaka on the post condition in the Web service data 41 are applied to the precondition “Located (user, from)”, with the result that the predicate “LocatedAt (Tanaka, Tokyo)” is created.

If the unification process of the predicate of the post condition in the web server 1 or the matching process has failed, the user cannot receive the desired Web service. Moreover, even if a predicate of the post condition is created, the user cannot use the Web service, unless the predicate of the precondition obtained by the unification process satisfies the predicate of the user's request.

In an example shown in FIG. 5, predicates for the post condition can be created for Web services 41 to 47. However, predicates for the precondition fulfilling the user data cannot be created for the pieces of Web service data excluding the piece of Web service data 41. Thus, only the Web service data 41 satisfies the user's request. That is, the Web service 41 can be set as one of the plans fulfilling the user's request.

In the above procedure, whether the user's request can be satisfied is determined on the basis of a certain Web service. In the second embodiment, furthermore, it is determined whether the user's request can be satisfied by combining a plurality of Web services.

For example, in the case of Web service data 45, the data doesn't have a predicate with the predicate symbol “Traveled” in the precondition. Thus, the data cannot be matched with the predicate of the user request data in terms of “Traveled”. However, concerning “StayedAt (user, location)”, the predicate “StayedAt (Tanaka, Osaka)” can be created by a unification process. That is, by unification process, the predicate “LocatedAt (Tanaka, Osaka)” in the precondition can be created.

Using the predicate as the post condition, the web server 1 searches for a piece of Web service data capable of creating a predicate for “Traveled (user, from, to)” in the Web service data. That is, by linking to one piece of Web service data incapable of providing the Web service requested by the user, another piece of Web service data capable of providing the Web service meeting the user's request is searched for.

Specifically, the web server 1 matches the created predicate data with the predicate data about the post condition in another piece of Web service data. In other words, when the predicate of the post condition created from certain Web service data fulfills the precondition for another Web service data, the web server 1 checks whether the predicate of the post condition created from second Web service data fulfills the predicate of the user's request not satisfied yet.

For example, for Web service 45, the precondition predicate “LocatedAt (Tanaka, Osaka)” is created. Giving priority to the created predicate, the web server 1 creates the predicate of an post condition from services excluding Web service 42. Services excluding Web service 42 include the predicate “LocatedAt (Tanaka, Osaka)” as an precondition. Then, the web server 1 combines the predicate of the post condition with the post condition created in Web service 42, thereby determining whether to satisfy the user's request.

For example, the predicate symbol “StayedAt” is included in both of the post condition in the Web service 45 and the post condition in the Web service 47. As a result of the unification process, the post condition in the Web service data 45 and the post condition in the Web service data 47 fulfill the request data predicate “StayedAt (Tanaka, Osaka)”. The precondition in the Web service 47 includes the predicate symbol “HaveStayedAT”. In the user data, the precondition is not met. In addition, none of the post conditions in the other Web services include “HaveStayedAt”.

On the other hand, the post condition in the Web service 2 includes two predicate symbols, “Traveled” and “LocatedAt”. By unification process giving user=Tanaka, from=Tokyo, to=Osaka, the predicate “Traveled (Tanaka, Tokyo, Osaka” and the predicate “LocatedAt (Tanaka, Osaka)” are created.

The predicate “Traveled (Tanaka, Tokyo, Osaka)” fulfills the request data. The predicate “LocatedAt (Tanaka, Osaka)” meets the predicate “LocatedAt (Tanaka, Osaka)” of the precondition in the Web service 45. Furthermore, the precondition in the Web service data 42 is “LocatedAt (Tanaka, Tokyo)”. The user data satisfies this condition. Therefore, combining the pieces of Web service data 42 and 45 makes it possible to satisfy the user data.

Similarly, combining the pieces of Web service data 44 and 45 also makes it possible to satisfy the user's request.

As described above, the web server 1 determines whether the user's request can be satisfied by combining a plurality of Web services. This enables the web server 1 to show a plan including not only a Web service covered by only one Web service but also a combination of a plurality of Web services in response to the user's request.

Therefore, the second embodiment also produces the same effect as that of the first embodiment.

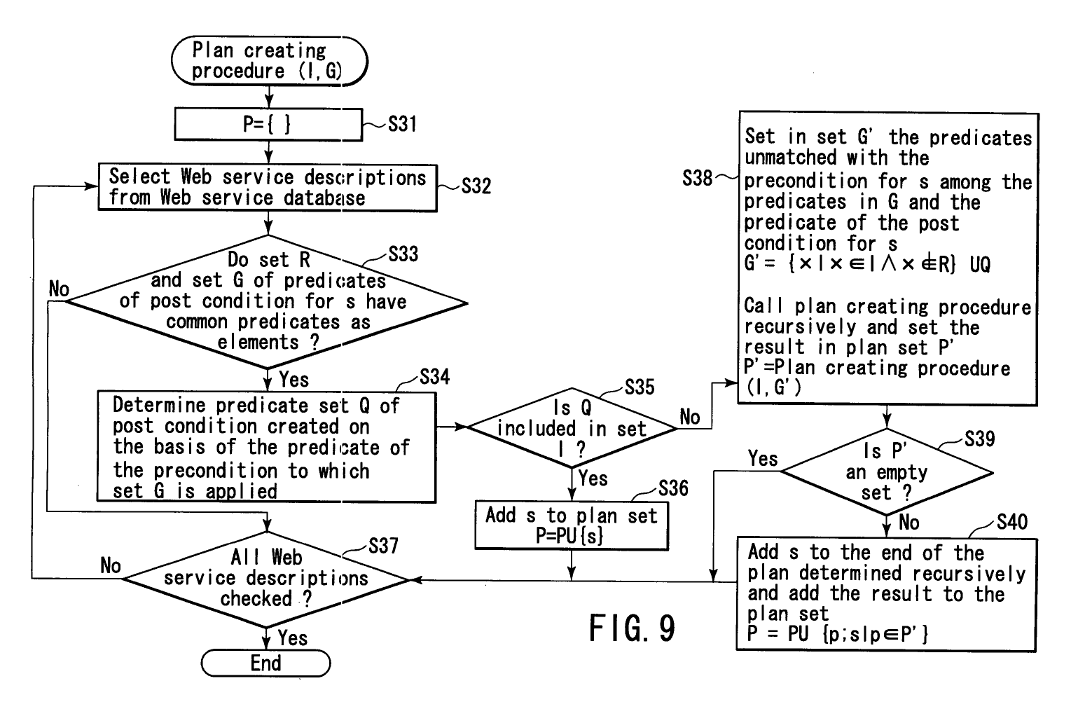

Next, the processes carried out by the web server 1 will be explained in detail by reference to FIGS. 8 and 9.

FIG. 8 is a flowchart to help explain another example of the processing procedure for the plan creating section 11.

After a preliminary process similar to that in the first embodiment, the linking plan creating section 16 carries out a plan creating procedure process using the user data and the user's request (step S3). The details of the process in this step will be explained later by reference to FIG. 9. Next, the web server 1 returns the plan created by the linking plan creating section 16 to PC2 that transmitted the user's request (step S4).

FIG. 9 is a detailed flowchart to help explain the procedure for the plan creating procedure process (step S3) of FIG. 8. First, the linking plan creating section 16 clears the data about plans (step S31). As a result, the set P of plans includes nothing.

Next, the linking plan creating section 16 selects Web service descriptions from the Web service data (step S32). In this step, the Web service description indicated by numeral 41 of FIG. 5 is selected.

Then, the linking plan creating section 16 determines whether common predicates are included in the predicate set R of the post conditions in the selected Web service descriptions and a predicate set G of user request data (step S33). That is, the linking plan creating section 16 matches the predicate set R of post conditions in the selected Web service descriptions with the predicate set G of user request data.

By a unification process giving user=Tanaka, from=Tokyo, to=Osaka, the post condition for the Web service 41 is “Traveled (Tanaka, Tokyo, Osaka) [symbol] StayedAt (Tanaka, Osaka) [symbol] LocatedAt [symbol] (Tanaka, Osaka)”. This meets expression (1) in connection with the user's request data. Thus, “Yes” is given in step S33 and the processing procedure goes to step S34. If “No” is given in step S33, the processing procedure proceeds to step S37.

In step S34, a set Q of predicates of the precondition created on the basis of the predicate of the post condition to which the set G of user request data is applied is determined. For example, the user's request data “Traveled (Tanaka, Tokyo, Osaka)” and “StayedAt (Tanaka, Osaka)” are used as a predicate of the post condition in the Web service data 41. Then, a predicate for the precondition is determined, which gives a predicate set {LocatedAt (Tanaka, Tokyo)}.

Next, the linking plan creating section 16 determines whether the set Q of the created precondition predicates includes the set I of predicates in the user data (step S35). That is, the linking plan creating section 16 matches the set Q of the created precondition predicates with the set I of predicates in the user data.

The predicate set Q of preconditions in the Web service 41 is {LocatedAt (Tanaka, Tokyo)} and the predicate set I of the user data is {LocatedAt (Tanaka, Tokyo)}. Thus, the set Q of predicates for the precondition is included in the set I of predicates in the user data. Thus, in step S35, “Yes” is given and the processing procedure goes to step S36.

In step S36, “s” is added to the plan set P. S1, the service ID of the Web service data 41, is added to the plan set P, giving P={S1}.

Next, the linking plan creating section 16 determines whether the descriptions of all the Web services have been checked (step S37). Taking FIG. 5 as an example, since six pieces of Web service data 42 to 47 are left in addition to the piece of Web service data 41, “No” is given in step S37 in this stage and the processing procedure returns to step S12.

Next, the linking plan creating section 16 carries out the same process for the piece of Web service data 42. That is, the linking plan creating section 16 selects the Web service descriptions indicated by numeral 42 in FIG. 5 (step S32).

Then, the linking plan creating section 16 determines whether the predicate set R of the post condition in the selected Web service descriptions and the set G of user's request data include common predicates (step S33).

By a unification process giving user=Tanaka, from=Tokyo, to=Osaka, the predicate “Traveled (Tanaka, Tokyo, Osaka)” is included in both the predicate of the post condition in the Web service data 42 and the predicate (expression (1)) in the user's request data. Thus, in step S33, “Yes” is given and the processing procedure proceeds to step S34.

In step S34, a set R of predicates for the post condition created on the basis of the predicate of the post condition to which the set G of the user's request data is applied is obtained. When a predicate for the precondition in the Web service data 42 is determined, this gives a set of predicates, {Traveled (LocatedAt (Tanaka, Osaka)).

Next, the linking plan creating section 16 determines whether the set Q of predicates for the created precondition includes the set I of predicates for the user data (step S35). The set Q of predicates for the post condition in the Web service data 45 is {LocatedAt (Tanaka, Osaka)}. The set I of predicates for the user data is {LocatedAt (Tanaka, Tokyo)}. Thus, the set Q of predicates for the precondition dose not include the set I of predicates for the user data. Thus, in step S35, “No” is given and the processing procedure proceeds to step S38.

As in the Web service data 42, in the Web service data 43, 44, too, the predicate set of preconditions is not included in the predicate set I of user data.

Next, the linking plan creating section 16 carries out the same process of the Web service data 45 as that of the Web service data 41. The linking plan creating section 16 selects Web service descriptions from the Web service data (step S32). In this case, the description in the Web service data 45 of FIG. 5 is selected.

Then, the linking plan creating section 16 determines whether the predicate set R of post conditions for the selected Web service descriptions and the set G of user's request data include common predicates (step S33). By a unification process giving user=Tanaka, location=Osaka, the predicate of the post condition in the Web service data 45 is “StayedAt (Tanaka, Osaka) [symbol] LocatedAt [symbol] (Tanaka, Osaka)”. This meets “StayedAt (Tanaka, Osaka)” in expression (1) in the user's request data. Thus, “Yes” is given in step S33 and the processing procedure goes to step S34.

In step S34, the linking plan creating section 16 determines a set Q of predicates for the precondition created on the basis of the predicate of the post condition to which the set G of user's request data is applied. For example, the user's request data “Traveled (Tanaka, Osaka)” and “StayedAt (Tanaka, Osaka)” are used as the predicate of the post condition in the Web service data 45. Then, a predicate for the precondition is determined, which gives a predicate set {LocatedAt (Tanaka, Osaka)}.

Next, the linking plan creating section 16 determines whether the set Q of predicates for the created precondition includes the set I of predicates in the user data (step S35). As for the Web service data 45, the precondition predicate set Q is {LocatedAt (Tanaka, Osaka)} and the user data predicate set I is {LocatedAt (Tanaka, Tokyo)}. Therefore, the set Q of predicates for the precondition is not included in the set I of predicates in the user data. As a result, as for the Web service data 45, “No” is given in step S35 and the processing procedure proceeds to step S38.

In step S38, the linking plan creating section 16 sets in the set (G′) the predicates unmatched with the post condition for the selected Web service descriptions among the predicates in the set G of user's request data and the predicate x of the precondition for the Web service descriptions. This process is expressed by equation (6):

G′={x|x∈G [symbol] x∉R} (6)

That is, G′={the predicates unmatched with the predicate of the post condition for the selected Web service descriptions among the predicates in the set G} {the predicates of the preconditions for the selected Web service descriptions}.

As for the Web service data 45, the predicate “Traveled (Tanaka, Tokyo, Osaka)” unmatched with the post conditions for the selected Web service descriptions among the set G of user's request data and the predicate “LocatedAt (Tanaka, Osaka)” of the precondition are set in the set (G′).

Next, the linking plan creating section 16 calls the plan creating procedure recursively and sets the result in a plan set P′. This process is expressed by equation (7):

P′=plan creating procedure(I′, G′) (7)

Concerning the Web service data 42, the set (G′) is {Traveled (Tanaka, Tokyo, Osaka), LocatedAt (Tanaka, Osaka)}. Thus, on the basis of the set (I) and the set (G′), the process of FIG. 9 is called recursively, with the result that the plan set (P′) is created.

After the process in step S38, the process in step S39 is carried out. In step S39, the linking plan creating section 16 determines whether the set P′ is an empty set. If the set P′ is an empty set, “Yes” is given in step S39 and the processing procedure goes to the process in step S37. If the set P′ is not an empty, “No” is given in step S39 and the processing procedure proceeds to step S40. In step S40, “s” is added to the end of the plan determined recursively and the resulting plan is added to the set P of plans. This process is expressed by the following equation (8):

P=P∪{s;p|p∈P′} (8)

The pieces of Web service data 42 and 44 are included in the plan P′. Thus, “S2; S5” and “S4; S5” in the Web service data 45 are added to S1 in the Web service data 41, with the result that the set P is {S1, S2; S5, S4; S5}. That is, calling the Web service S4 or Web service S5 after the Web service S2 causes two plans fulfilling the user's request to be added.

Next, the processing procedure goes to step S37, where the same process is performed on the next Web service data 46. Concerning the Web service data 46, the post condition is “StayedAt (user, location) [symbol] LocatedAt (user, location) [symbol] HaveMileageAccount (user, airline) [symbol] GotMileagePoints (user, airline)”. Whether-to-use data in the user data 26 is “No”. Thus, in step S33, “No” is given. Similarly, the procedure of FIG. 9 is carried out for up to the Web service data 47.

As a result of such processes, three plans satisfying the user's request are created. The web server 1 transmits the plans to PC2. That is, the data corresponding to the set P (={S1, S2; S5, S4; S5}) is returned to PC2 that transmitted the user's request. PC2 shows the data to the user. Although a plurality of pieces of list data about the identifiers of the Web service descriptions in the Web service data have been returned, data other than the identifiers may be returned.

Next, a case where whether-to-use data in the user data 26 of FIG. 3 is “Yes” will be explained.

If whether-to-use data in the user data 26 is “Yes”, the user data set I is {LocatedAt (Tanaka, Tokyo), HaveMileageAccount (Tanaka, A company)}. In this case, since the processing procedure for the Web services S1 to S5 is the same as described above, its explanation will be omitted.

As for the Web service S6, since the precondition predicate set {StayedAt (Tanaka, Osaka), LocatedAt (Tanaka, Osaka), HaveMileageAccount (Tanaka, A company), GotMileagePoints (Tanaka, A company) has a predicate set common to the predicate set G in the user's request data. Thus, “Yes” is given in step S33. Since the precondition predicate set {LocatedAt (Tanaka, Osaka), HaveMileageAccount (Tanaka, A company)} is not included in the predicate set I of user data, “No” is given in step S35. As a result, the processing procedure goes to step S38.

In step S38, the linking plan creating section 16 creates the set (G′), which gives G′={the predicates unmatched with the predicate of the post condition in the Web service S6 among the predicates in the set G}∪{the predicate of the precondition in the Web service S6}={Traveled (Tanaka, Tokyo, Osaka)∪LocatedAt (Tanaka, Osaka), HaveMileageAccount (Tanaka, A company)}=(Traveled (Tanaka, Tokyo, Osaka), LocatedAt (Tanaka, Osaka), HaveMileageAccount (Tanaka, A company)}.

Then, the linking plan creating section 16 calls the plan creating procedure recursively on the basis of the set I′ and the set G′ and carries out it, thereby searching for the Web service that satisfies “Traveled (Tanaka, Tokyo, Osaka)”.

The predicate set {Traveled (Tanaka, Tokyo, Osaka), LocatedAt (Tanaka, Osaka), HaveMileageAccount (Tanaka, A company), GotMileagePoints (Tanaka, A company)} of the post condition in the Web service S3 has a predicate common to that of the set (G′). Thus, in step S33, “Yes” is given. Furthermore, since the precondition predicate set {LocatedAt (Tanaka, Tokyo), HaveMileageAccount (Tanaka, A company)} is included in the set (I), “Yes” is give in step S35. As a result, “S3; S6” is added to the plan P. That is, the data corresponding to the set P (={S1, S2; S5, S3; S6, S4; S5}) is returned to PC2 that transmitted the user's request.

As described above in detail, with the second embodiment, too, the user can receive not only one Web service but also a combination of a plurality of Web services as a service plan satisfying the user's request. Therefore, the user can get more Web service information satisfying the user's request than in a conventional equivalent.

All of or part of the program realizing the above-described operation is stored onto a removable medium, such as a floppy disk (registered trademark) or a CD-ROM, or onto a storage device, such as a hard disk. The program is read into a computer, which executes all of or part of the processes.

Furthermore, all of or part of the program may be distributed or provided through a communication network. The user can download the program via a communication network, and install the program into the computer, or install the program from a recording medium into the computer, thereby realizing an application program plan-creating system easily.

This invention is not limited to the above embodiments and may be practiced or modified in still other ways without departing from the spirit or essential character thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A Web service coordination plan creating apparatus, comprising:
a first storage section which stores user data that makes predicates indicating a states of a user;
a second storage section which stores a database that associates preconditions representing, in predicate form, necessary conditions for users to use Web services via an information communication network, with post conditions representing, in predicate form, the effects of invocation of the corresponding Web services; and
coordination plan creating means for, when receiving a user's request including search conditions for the Web services, acquiring matching user data in predicate form corresponding to the user's request from the first storage section, acquiring from the second storage a combination of Web services which satisfies the user's request by logically combining the preconditions and post conditions for a plurality of Web services including a Web service having the preconditions matching with the user data and a Web service having the post conditions matching with the user data, and creating a Web service linking plan where the individual Web services included in the combination are arranged in the order of the logical combination.

2. The Web service coordination plan creating apparatus according to claim 1, wherein
the coordination plan creating means carries out
a first process of matching the predicate of the precondition with the predicate of the user data and matching the predicate of the post condition with the predicate of the user's request in respect to one Web service, and
a second process of matching the predicate of the precondition with a first predicate including the predicate of the user data unmatched in the first process and matching the predicate of the post condition with a second predicate including the predicate of the user's request unmatched in the first process in respect to other Web services excluding the one Web service.

3. The Web service coordination plan creating apparatus according to claim 2, wherein
the coordination plan creating means carries out the second process by calling the first process recursively.

4. The Web service coordination plan creating apparatus according to claim 1, wherein
the coordination plan creating means carries out
a first process of matching the predicate of the precondition with the predicate of the user data and matching the predicate of the post condition with the predicate of the user's request in respect to one Web service, and
a third process of matching the predicate of the post condition with a third predicate including the predicate of the user's request unmatched in the first process in respect to other Web services excluding the one Web service.

5. The Web service coordination plan creating apparatus according to claim 4, wherein
the coordination plan creating means carries out the third process by calling the first process recursively.

6. The Web service coordination plan creating apparatus according to claim 1, further comprising:
a third storage section which stores an ontology dictionary where a plurality of predicates describing each state by predicate logic notation are classified hierarchically in database form, wherein
the coordination plan creating means creates matching user data by changing the predicate included in the user's request according to a hierarchical level in the ontology dictionary.

7. A Web service coordination plan creating method which uses user data that makes predicates indicating the states of users and a database that associates preconditions representing, in predicate form, necessary conditions for users to use Web services via an information communication network, with post conditions representing, in predicate form, the result of receiving the Web services to correspond to the Web services, the Web service linking plan method comprising:
a first step of, when receiving a user's request including search conditions for the Web services, acquiring matching user data in predicate form corresponding to the user's request from a first storage section;
a second step of acquiring from the second storage a combination of Web services which satisfies the user's request by logically combining the preconditions and post conditions for a plurality of Web services including a Web service having the preconditions matching with the user data and a Web service having the post conditions matching with the user data; and
a third step of creating a Web service linking plan where the individual Web services included in the combination acquired in the second step are arranged in the order of the logical combination.

8. The Web service coordination plan creating method according to claim 7, wherein
the second step includes
a fourth step of matching the predicate of the precondition with the predicate of the user data and matching the predicate of the post condition with the predicate of the user's request in respect to one Web service, and
a fifth step of matching the predicate of the precondition with a first predicate including the predicate of the user data unmatched in the fourth step and matching the predicate of the post condition with a second predicate including the predicate of the user's request unmatched in the fourth step in respect to other Web services excluding the one Web service.

9. The Web service coordination plan creating method according to claim 8, wherein
the second step is a step of carrying out the fifth step by calling the fourth step recursively.

10. The Web service coordination plan creating method according to claim 7, wherein
the second step includes
a sixth step of matching the predicate of the precondition with the predicate of the user data and matching the predicate of the post condition with the predicate of the user's request in respect to one Web service, and
a seventh step of matching the predicate of the post condition with a third predicate including the predicate of the user's request unmatched in the sixth step in respect to other Web services excluding the one Web service.

11. The Web service coordination plan creating method according to claim 10, wherein
the second step is a step of carrying out the seventh step by calling the sixth step recursively.

12. The Web service coordination plan creating method according to claim 7, further comprising:
using an ontology dictionary where a plurality of predicates describing each state by predicate logic notation are classified hierarchically in database form, wherein
the first step is a step of creating matching user data by changing the predicate included in the user's request according to a hierarchical level in the ontology dictionary.

13. A recording medium which records a program for causing a computer to carry out a Web service coordination plan creating method which uses user data that makes predicates indicating the states of users and a database that associates preconditions representing, in predicate form, necessary conditions for users to use Web services via an information communication network, with post conditions representing, in predicate form, the result of receiving the Web services to correspond to the Web services, the program comprising:
a first instruction which causes the computer to execute a first step of, when receiving a user's request including search conditions for the Web services, acquiring matching user data in predicate form corresponding to the user's request from a first storage section;
a second instruction which causes the computer to execute a second step of acquiring from the second storage a combination of Web services which satisfies the user's request by logically combining the preconditions and post conditions for a plurality of Web services including a Web service having the preconditions matching with the user data and a Web service having the post conditions matching with the user data; and
a third instruction which causes the computer to execute a third step of creating a Web service linking plan where the individual Web services included in the combination acquired in the second step are arranged in the order of the logical combination.

14. The recording medium according to claim 13, wherein
the second instruction includes
a fourth instruction which causes the computer to execute a fourth step of matching the predicate of the precondition with the predicate of the user data and matching the predicate of the post condition with the predicate of the user's request in respect to one Web service, and
a fifth instruction which causes the computer to execute a fifth step of matching the predicate of the precondition with a first predicate including the predicate of the user data unmatched in the fourth step and matching the predicate of the post condition with a second predicate including the predicate of the user's request unmatched in the fourth step in respect to other Web services excluding the one Web service.

15. The recording medium according to claim 14, wherein
the second step is a step of carrying out the fifth step by calling the fourth step recursively.

16. The recording medium according to claim 13, wherein
the second instruction includes
a sixth instruction which causes the computer to execute a sixth step of matching the predicate of the precondition with the predicate of the user data and matching the predicate of the post condition with the predicate of the user's request in respect to one Web service, and
a seventh instruction which causes the computer to execute a seventh step of matching the predicate of the post condition with a third predicate including the predicate of the user's request unmatched in the sixth step in respect to other Web services excluding the one Web service.

17. The recording medium according to claim 16, wherein
the second step is a step of carrying out the seventh step by calling the sixth step recursively.

18. The recording medium according to claim 13, further comprising:
using an ontology dictionary where a plurality of predicates describing each state by predicate logic notation are classified hierarchically in database form, wherein
the fist step is a step of creating matching user data by changing the predicate included in the user's request according to a hierarchical level in the ontology dictionary.
